(19) United States
(12) Patent Application Publication
(10) Pub. No.: US 2025/0250008 A1
(43) Pub. Date: Aug. 7, 2025

(54) ENERGY ABSORBING SEAT BELT SHACKLE AND SEAT BELT ASSEMBLY

(71) Applicant: B/E Aerospace, Inc., Winston-Salem, NC (US)

(72) Inventors: Pradeep Acharya, Bangalore (IN); Sreekanth Rao, Bangalore (IN); Pallavi Doddenahalli Shekharappa, Hassan (IN); Sourabh Vijaya Manae, Bengaluru (IN)

(21) Appl. No.: 19/045,290

(22) Filed: Feb. 4, 2025

(30) Foreign Application Priority Data
Feb. 7, 2024 (IN) 202441008295

(51) Int. Cl. B64D 11/06

(52) U.S. Cl. CPC B64D 11/062

(57) ABSTRACT

An energy absorbing seat belt shackle for use with a seat belt such as a two point lap belt. The shackle includes a cage having a first end rotatably attachable to an anchoring member and a second end having an axial opening, a bolt positioned in the cage and extending through the axial opening, a clevis having a first end attached to the bolt and a second end for rotatably attaching a seat belt anchor, a bushing mounted on the bolt, and a deformable energy absorber mounted on the bolt and axially constrained between the bushing and the second end of the cage. In use, tension on the seat belt shackle exceeding a predefined threshold value causes the deformable energy absorber to axially compress in a predictable manner.

### CROSS REFERENCE TO RELATED APPLICATION

This nonprovisional application claims the benefit of priority of Indian Patent Application number 202441008295 filed Feb. 7, 2024, which is hereby incorporated by reference in its entirety.

### TECHNICAL FIELD AND BACKGROUND

The present disclosure relates generally to an energy absorbing device, and more particularly, to a seat belt shackle configured to absorb energy with a minimal stroke distance and in a predictable manner.

Virtually every aspect of aircraft passenger seat design is constrained by requirements imposed by safety, weight, and cost considerations. For example, regulatory requirements for aircraft components in the U.S. are based on Title 14 of the Code of Federal Regulations (CFR) Part 25, which sets out standards for aircraft airworthiness. For aircraft passenger seats, Part 25 specifies requirements for impact loads and head injury criteria (HIC) that may give passengers a reasonable chance of escaping serious injury in a minor crash landing situation.

Conventional aircraft passenger seats address these requirements by employing reinforced seat components, dynamic passenger restraints, and breakover mechanisms. While effective to a degree, these conventional solutions are implemented at the expense of complexity, weight, and cost of the passenger seat. Therefore, what is needed is a solution for improving seat safety and performance while overcoming the disadvantages of conventional solutions.

### BRIEF SUMMARY

According to one aspect, the inventive concepts according to the present disclosure are directed to an energy absorbing seat belt shackle. In embodiments, the shackle includes a body such as a cage having a first end rotatably attachable to an anchoring member and a second end having an axial opening, a bolt positioned in the cage and extending through the axial opening, a clevis having a first end attached to the bolt and a second end for rotatably attaching a seat belt anchor, a bushing mounted on the bolt, and a deformable energy absorber mounted on the bolt and axially constrained between the bushing and the second end of the cage.

In embodiments, in use, tension on the energy absorbing seat belt shackle exceeding a predefined threshold value causes the bolt to be pulled toward the second end of the cage thereby causing the deformable energy absorber to undergo plastic deformation.

In some embodiments, the deformable energy absorber is a collapsible tube and the plastic deformation is axial compression.

In some embodiments, a diameter of the collapsible tube is between 0.50 inches and 0.75 inches, a wall thickness of the collapsible tube is between 0.01 inches and 0.03 inches, and a length of the collapsible tube is between 1.00 inch and 1.50 inches.

In some embodiments, the cage is a boxlike enclosure having one open end and at least one open side.

In some embodiments, movement of the clevis apart from the cage, as a result of axial compression of the deformable energy absorber, is no more than 0.75 inches.

In some embodiments, the bolt and the clevis are threadably engaged, and the clevis has a forked end receiving a clevis pin retained to the clevis by a split pin.

According to another aspect, the inventive concepts according to the present disclosure are directed to a seat belt assembly including a two-point lap belt assembly including seat belt anchors, and an energy absorbing shackle rotatably attached to each one of the seat belt anchors. In embodiments, the energy absorbing shackle includes a cage having a first end rotatably attachable to an anchoring member and a second end having an axial opening, a bolt positioned in the cage and extending through the axial opening, a clevis having a first end attached to the bolt and a second end rotatably attached to the respective one of the seat belt anchors, a bushing mounted on the bolt, and a deformable energy absorber mounted on the bolt and axially constrained between the bushing and the second end of the cage.

According to a further aspect, the inventive concepts according to the present disclosure are directed to an assembly for an aircraft passenger seat. In embodiments, the assembly includes a spreader, and an energy absorbing seat belt shackle including a cage rotatably attached to the spreader and having an axial opening at one end of the cage, a bolt positioned in the cage and extending through the axial opening, a clevis attached to the bolt, a bushing mounted on the bolt, and a deformable energy absorber mounted on the bolt and axially constrained between the bushing and the second end of the cage.

In some embodiments, a rotation limiting feature is provided on the first end of the cage configured to interact with the spreader to limit rotation of the energy absorbing seat belt shackle relative to the spreader.

This summary is provided solely as an introduction to subject matter that is fully described in the following detailed description and drawing figures. This summary should not be considered to describe essential features nor be used to determine the scope of the claims. Moreover, it is to be understood that both the foregoing summary and the following detailed description are explanatory only and are not necessarily restrictive of the subject matter claimed.

### BRIEF DESCRIPTION OF THE DRAWINGS

Implementations of the inventive concepts disclosed herein may be better understood when consideration is given to the following detailed description thereof. Such description refers to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1A is a side view of a passenger seat assembly including a spreader and an attached energy absorbing seat belt shackle, in accordance with example embodiments of this disclosure;

FIG. 1B is a detailed view of FIG. 1A showing a rotation limiting feature of the shackle configured to interface with the spreader, in accordance with example embodiments of this disclosure;

FIG. 2 is an exploded view of a seat belt assembly including a two-point seat belt and energy absorbing seat belt shackles, in accordance with example embodiments of this disclosure;

FIG. 3 is isometric view of an energy absorbing seat belt shackle shown in an assembled state, in accordance with example embodiments of this disclosure;

FIG. 4 is an exploded view of the energy absorbing seat belt shackle shown in FIG. 3, in accordance with example embodiments of this disclosure;

FIG. 5A illustrates schematically a collapsible tube configuration for the energy absorber shown in an intact state, in accordance with example embodiments of this disclosure;

FIG. 5B illustrate schematically the collapsible tube after being axially compressed, in accordance with example embodiments of this disclosure; and

FIG. 6 is a perspective view of the energy absorbing seat belt shackle showing the deformable energy absorber in a plastically deformed state, in accordance with example embodiments of this disclosure.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein, a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, embodiments of the inventive concepts disclosed herein are directed to an energy absorbing shackle for use with a seat belt, seat belt assemblies including energy absorbing shackles, and passenger restraint assemblies for passenger seats such as aircraft passenger seats. In use, the shackle couples a seat belt part to an anchoring member such as a seat spreader. During a dynamic event, for instance a sudden deceleration of sufficient magnitude, the shackle performs to absorb impact energy with a minimum stroke distance and in a predictable manner. In embodiments, the shackle operates as a rigid link during normal use of the seat, and operates to absorb impact energy during a dynamic event. In embodiments, the shackle is particularly well suited for use with a seat belt, for instance a two-point lap belt.

Benefits and advantages of the energy absorbing seat belt shackle according to the present disclosure include, but are not limited to, reduced impact load (e.g., about 15%), reduced stresses on seat components (e.g., about 35%), improved seat belt performance, weight reduction (e.g., about 10%), predictable and repeatable performance, and serviceability.

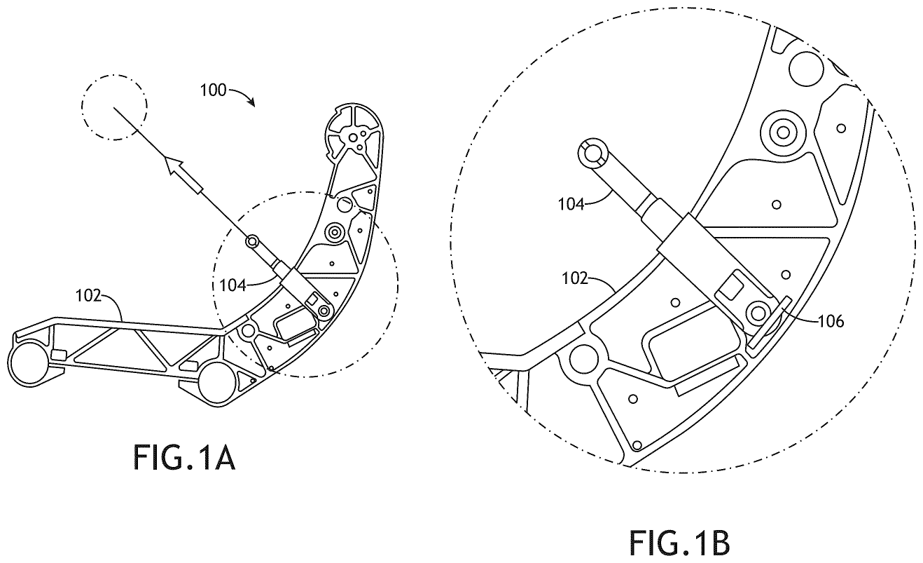

FIGS. 1A and 1B illustrate a passenger seat assembly 100 according to the present disclosure. In embodiments, the passenger seat assembly 100 includes a spreader 102, and an energy absorbing seat belt shackle 104 pivotably, rotatably, or otherwise attached to the spreader 102. In use, the spreader 102 serves as a rigid anchoring member for a seat belt assembly. Known to those skilled in the art of aircraft passenger seats, spreaders 102 may further serve to support fixed and dynamic attachments such as fore and aft beam tubes, seat legs, rotating seat backs, translating seat pans, and rotating armrests. Aircraft passenger seats typically include two spaced spreaders supporting a seat pan and a seat back, wherein each spreader serves to anchor one end of the seat belt, and wherein the seat belt spans across the width of the seat.

As shown, the shackle 104 is positioned on the spreader 102 at about waist height for rotatably attaching a seat belt anchor. In use, loads imparted on the seat belt as the passenger moves are transferred to the spreader 102 via the shackle 104, and typically from the spreader 102 to the legs, and ultimately to the floor of the aircraft. During normal use of the passenger seat (e.g., inertial load up to about 9 g to cover regular use of the passenger seat including abuse loads), the shackle 104 performs as a rigid link. During a dynamic event exceeding a predefine limit load (e.g., inertial load greater than about 14 g or 16 g), the shackle 104 performs dynamically to absorb impact energy to reduce the impact load on the seat and the passenger. In embodiments, the dynamic performance is destructive to an energy absorbing component of the shackle 104, necessitating repair or replacement after each dynamic event. In embodiments, the shackle 104 may be tuned to begin stroking in a guided path predefined limit load (e.g., inertial load greater than about 9 g or 12 g) to ensure that the shackle 104 performs at when the required limit load is exceeded (e.g., 14 g or 16 g). FIG. 1B illustrates a particular configuration of the shackle 104 including a rotation limiter 106 positioned at the rotatably attached end of the shackle 104. In use, the rotation limiter 106 maintains the shackle 106 at the appropriate angle for use and for locating the attached seat belt.

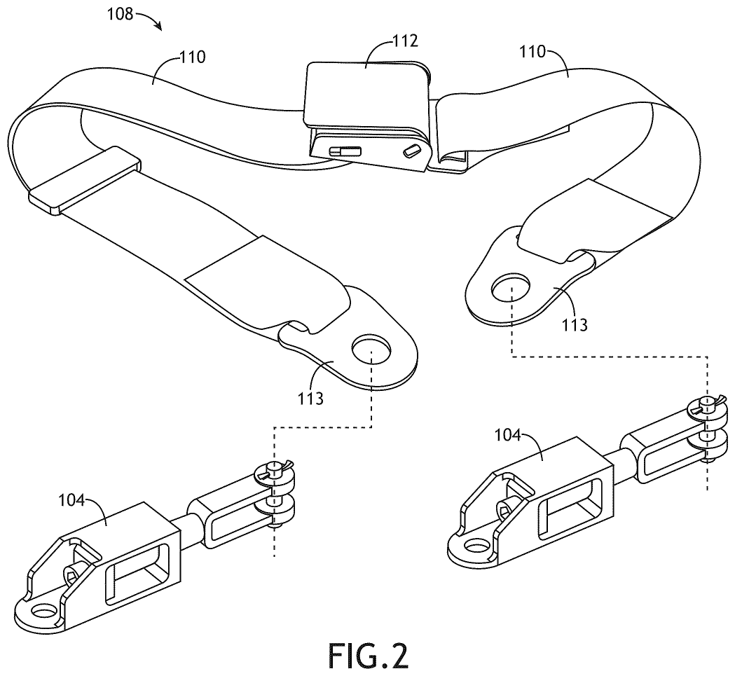

FIG. 2 illustrates a seat belt assembly 108 according to the present disclosure. In embodiments, the seat belt assembly 108 includes a two-point lap belt assembly including webbing 110, an aircraft style buckle 112, and seat belt anchors 113 positioned at opposite ends of the assembly 108. Each seat belt anchor 113 is configured to rotatably attach to one end of an energy absorbing seat belt shackle 104.

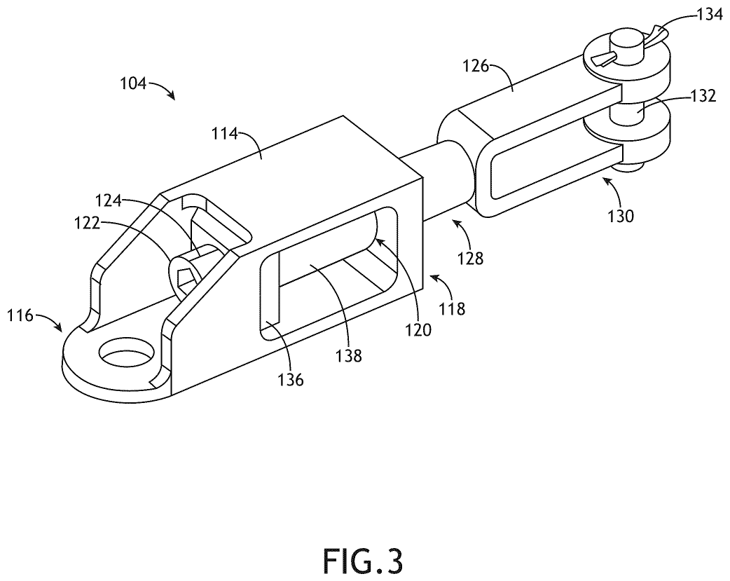

FIG. 3 illustrates the energy absorbing seat belt shackle 104 according to the present disclosure. In embodiments, the shackle 104 includes a housing or main body such as a cage 114 having a first end 116 rotatably attachable to an anchoring member (e.g., spreader), and a second end 118 having an axial opening 120. A bolt 122 is disposed in an interior space formed in the cage 114, and one end of the bolt 122 extends through the axial opening 120. In some embodiments, the bolt is externally threaded and includes a head 124 at one end configured to receive a tool for turning the bolt 122. The shackle 104 further includes a clevis 126 positioned at the second end 118 of the cage 114. The clevis 126 has a first end 128 positioned facing and axially aligned with the axial opening 120, and a forked end 130 receiving a clevis pin 132 retained to the clevis 126 by a split pin 134. In embodiments, a seat belt anchor is positioned in the forked end 130 and the clevis pin 132 is installed through an opening formed in the seat belt anchor to rotatably attach the seat belt to the shackle 104.

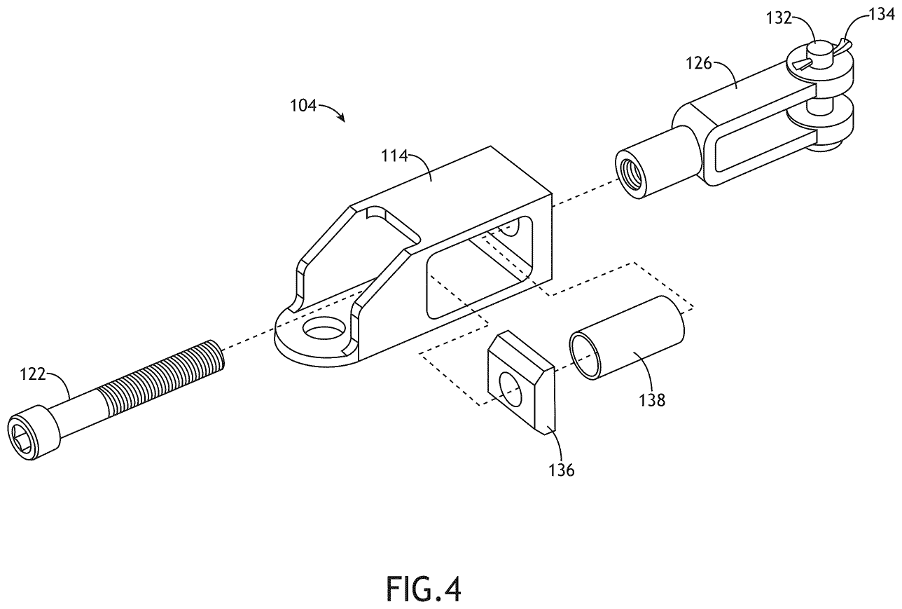

The shackle 104 further includes a bushing 136 mounted on the bolt 122 abutting against the head 124, and a deformable energy absorber 138 mounted on the bolt 122 and axially constrained between the bushing 136 and the second end 118 of the cage 114. In this configuration, each of the bushing 136 and the deformable energy absorber 138 are carried by the bolt 122 such that, as the bolt 122 is threaded into the first end 128 of the clevis 126 and tightened, the deformable energy absorber 138 is constrained between the bushing 136 and the second end 118 of the cage 114. In some embodiments, the interior space formed in the cage 114 may be shaped to constrain the deformable energy absorber 138 radially or laterally as it deforms. As shown, the cage 114 has an open end to insert and access the bolt and at least one open side. Other cage configurations are envisioned, for instance a cage having a different shape and/or closed sides. FIG. 4 illustrates the shackle 104 in an exploded state to illustrate the various components and their attachments.

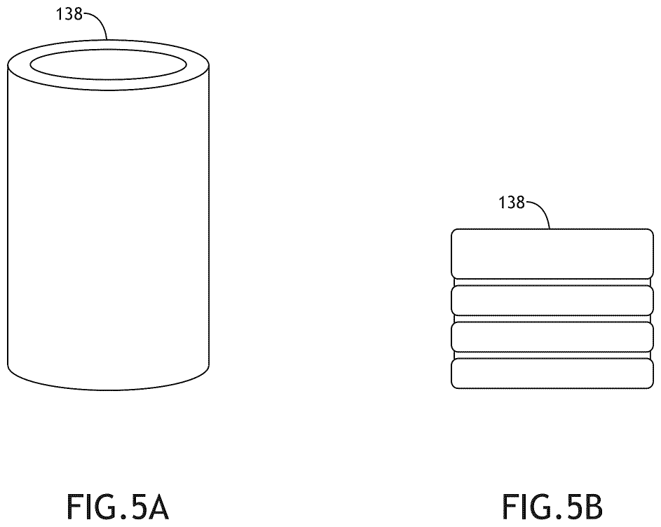

FIGS. 5A and 5B illustrate the deformable energy absorber 138 in its original (i.e., axially uncompressed) and deformed (i.e., axially compressed) states, respectively. In embodiments, the deformable energy absorber 138 is a thin walled collapsible tube made of, for example, aluminum alloy (e.g., Al-6061). In embodiments, the collapsible tube has a diameter between 0.50 inches and 0.75 inches, a wall thickness between 0.01 inches and 0.03 inches, and a length between 1.00 inch and 1.50 inches. In this configuration, the stroke distance may be limited to no more than 0.75 inches, and more preferably no more than 0.60 inches, to comply with the occupant displacement requirements for HIC pertaining to head path.

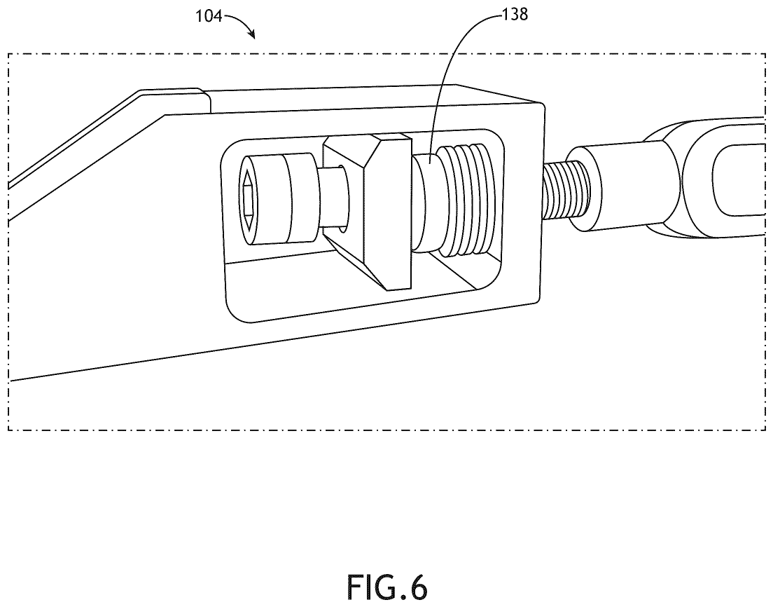

In embodiments, the deformable energy absorber 138 is the weakest (i.e., sacrificial) element of the shackle 104 such that, once the inertial load reaches the load limit, the shackle 104 begins stroking and the deformable energy absorber 138 begins to axially compress causing the deformable energy absorber 138 to, for example, buckle, crumple, fold, etc. FIG. 6 illustrates the deformable energy absorber 138 after undergoing plastic deformation. In embodiments, the deformable energy absorber 138 may be configured to plastically deform, elastoplastically deform, or resiliently deform depending on the configuration and material of the energy absorber 138. Other configurations for the deformable energy absorber 138 may include, but are not limited to, structures having a variable compressibility profile, mesh structures, additively manufactured structures, etc.

From the above description, it is clear that the inventive concepts disclosed herein are well adapted to achieve the objectives and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. An energy absorbing seat belt shackle, comprising:
a cage having a first end rotatably attachable to an anchoring member, and a second end having an axial opening;
a bolt positioned in the cage and extending through the axial opening;
a clevis having a first end attached to the bolt, and a second end for rotatably attaching a seat belt anchor;
a bushing mounted on the bolt; and
a deformable energy absorber mounted on the bolt and axially constrained between the bushing and the second end of the cage.

2. The energy absorbing seat belt shackle according to claim 1, wherein, in use, tension on the energy absorbing seat belt shackle exceeding a predefined threshold value causes the bolt to be pulled toward the second end of the cage thereby causing the deformable energy absorber to undergo plastic deformation.

3. The energy absorbing seat belt shackle according to claim 1, wherein the deformable energy absorber is a collapsible tube and the plastic deformation is axial compression.

4. The energy absorbing seat belt shackle according to claim 3, wherein:
a diameter of the collapsible tube is between 0.50 inches and 0.75 inches;
a wall thickness of the collapsible tube is between 0.01 inches and 0.03 inches; and
a length of the collapsible tube is between 1.00 inch and 1.50 inches.

5. The energy absorbing seat belt shackle according to claim 1, wherein the cage is a boxlike enclosure having one open end and at least one open side.

6. The energy absorbing seat belt shackle according to claim 1, wherein movement of the clevis apart from the cage, as a result of axial compression of the deformable energy absorber, is no more than 0.75 inches.

7. The energy absorbing seat belt shackle according to claim 1, wherein:
the bolt and the clevis are threadably engaged; and
the clevis has a forked end receiving a clevis pin retained to the clevis by a split pin.

8. A seat belt assembly, comprising:
a two-point lap belt assembly including seat belt anchors; and
an energy absorbing shackle rotatably attached to each seat belt anchor, the energy absorbing shackle comprising:
a cage having a first end rotatably attachable to an anchoring member, and a second end having an axial opening;
a bolt positioned in the cage and extending through the axial opening;
a clevis having a first end attached to the bolt, and a second end rotatably attached to the respective one of the seat belt anchors;
a bushing mounted on the bolt; and
a deformable energy absorber mounted on the bolt and axially constrained between the bushing and the second end of the cage.

9. The seat belt assembly according to claim 8, wherein, in use, tension on the two-point lap belt assembly exceeding a predefined threshold value causes, for each of the energy absorbing shackles, the bolt to be pulled toward the second end of the cage thereby causing the deformable energy absorber to undergo plastic deformation.

10. The seat belt assembly according to claim 9, wherein the deformable energy absorber is a collapsible tube and the plastic deformation is axial compression.

11. The seat belt assembly according to claim 10, wherein:
a diameter of the collapsible tube is between 0.50 inches and 0.75 inches;
a wall thickness of the collapsible tube is between 0.01 inches and 0.03 inches; and
a length of the collapsible tube is between 1.00 inch and 1.50 inches.

12. The seat belt assembly according to claim 10, wherein the collapsible tube is made of an aluminum alloy.

13. The seat belt assembly according to claim 8, wherein movement of the clevis apart from the cage, as a result of axial compression of the deformable energy absorber, is no more than 0.75 inches.

14. The seat belt assembly according to claim 8, wherein:
the bolt and the clevis are threadably engaged;
the clevis has a forked end receiving a clevis pin retained to the clevis by a split pin; and
the clevis pin is received through an opening in the respective one of the seat belt anchors.

15. An assembly for an aircraft passenger seat, comprising:
a spreader; and
an energy absorbing seat belt shackle, comprising:
a cage having a first end rotatably attached to the spreader, and a second end having an axial opening;
a bolt positioned in the cage and extending through the axial opening;
a clevis having a first end attached to the bolt, and a second end rotatably attachable to a seat belt anchor;
a bushing mounted on the bolt; and
a deformable energy absorber mounted on the bolt and axially constrained between the bushing and the second end of the cage.

16. The assembly according to claim 15, wherein, in use, tension on the energy absorbing seat belt shackle exceeding a predefined threshold value causes the bolt to be pulled toward the second end of the cage thereby causing the deformable energy absorber to undergo plastic deformation.

17. The assembly according to claim 16, wherein:
the deformable energy absorber is a collapsible tube made of an aluminum alloy;
a diameter of the collapsible tube is between 0.50 inches and 0.75 inches;
a wall thickness of the collapsible tube is between 0.01 inches and 0.03 inches; and
a length of the collapsible tube is between 1.00 inch and 1.50 inches.

18. The assembly according to claim 15, wherein movement of the clevis apart from the cage, as a result of axial compression of the deformable energy absorber, is no more than 0.75 inches.

19. The assembly according to claim 15, wherein:
the bolt and the clevis are threadably engaged;
the clevis has a forked end receiving a clevis pin retained to the clevis by a split pin; and
the clevis pin is receivable through opening formed in the seat belt anchor.

20. The assembly according to claim 15, wherein the energy absorbing seat belt shackle further comprising a rotation limiting feature provided on the first end of the cage configured to interact with the spreader to limit rotation of the energy absorbing seat belt shackle relative to the spreader.
